(19) United States
(12) Patent Application Publication
(10) Pub. No.: US 2009/0028039 A1
(43) Pub. Date: Jan. 29, 2009

(54) METHOD FOR PRODUCING OPTICAL INFORMATION RECORDING MEDIUM AND OPTICAL INFORMATION RECORDING MEDIUM

(76) Inventor: Kazuya Hisada, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/584,948

(22) PCT Filed: Sep. 5, 2005
(86) PCT No.: PCT/JP2005/016250

§ 371 Date: Jul. 5, 2006

(30) Foreign Application Priority Data
Sep. 8, 2004 (JP) 2004-261031

(51) Int. Cl. G11B 7/00; B05D 5/06

(52) U.S. Cl. 369/272.1; 427/162; G9B/7

(57) ABSTRACT

In case a convex portion acting as a protector is formed on a signal face of a disc by a liquid material such as radiation cure resin, two substantially concentric concave portions are preliminarily provided on a substrate. A liquid material is dripped onto a region interposed between the concave portions and is cured such that the convex portion having desired height and width can be formed on the region.

### TECHNICAL FIELD

The present invention generally relates to an optical information recording medium and its manufacturing method and more particularly, to a method of forming a convex portion on, for example, a disc and a medium formed with the convex portion.

### BACKGROUND ART

Recently, researches on various optical information recording techniques are pursued in the field of information recording. Since the optical information recording facilitates higher density and enables recording and reproduction in noncontact state, a wide range of applications for performing the optical information recording at low cost are being made. Optical discs in current use include a compact disc (CD) in which an information layer is provided on a transparent resinous substrate having a thickness of 1.2 mm and is protected by an overcoat layer and a digital versatile disc (DVD) in which two transparent resinous substrates each having a thickness of 0.6 mm are bonded to each other and an information layer is provided on one or both of the substrates.

In recent years, in order to raise recording density of the optical discs, a method in which a numerical aperture (NA) of an objective lens is increased and a method in which a wavelength of a laser in use is reduced are under study. At this time, as a thickness of a recording and reproducing base layer, i.e., one substrate at a side upon which a laser beam is incident becomes smaller, influence exerted on a laser spot by aberration can be lessened further and thus, a permissible value of a tilt angle of the disc can be increased further. Thus, as disclosed in, for example, Japanese Patent Laid-Open Publication No. 8-235638 (1996), a Blu-ray Disc is proposed in which the thickness of the recording and reproducing base layer is set to about 0.1 mm, the NA is set to abut 0.85 and the wavelength of the laser is set to about 400 nm.

At present, the Blu-ray Disc is commercially available and used as a rewritable disc which is contained in a cartridge. However, if a read-only disc or a write once read many disc is put on the market as the Blu-ray Disc in the future, it may be strongly desired that such discs also be used in an uncovered state as in the CD and the DVD. At this time, when a user tries to directly place the disc on a table or pick up the disc from the table, there is a risk that recording and reproduction cannot be performed on the disc due to damage to a recording and reproducing face of the disc. In order to obviate such a risk, it is preferable that a location projecting more than the recording and reproducing face of the disc be provided on the recording and reproducing face. Hereinafter, the projecting location on the recording and reproducing face is referred to as a “protector”.

Generally, in the CD and the DVD, the protector is formed at the time of injection molding of the substrate. However, in the Blu-ray Disc, after the substrate has been injection molded, it is necessary to form a thin light-transmissible layer on the recording and reproducing face or an intermediate layer for a multi-layer construction as disclosed in, for example, Japanese Patent Laid-Open Publication No. 2002-260307 (2002). Thus, if the protector is present on the substrate, these formation steps may become complicated or drop in accuracy. Therefore, the protector should be preferably formed after formation of the light-transmissible layer.

In order to form the protector after formation of the light-transmissible layer, a method may be initially devised in which a protector member is bonded to the substrate by a seal or adhesive. However, this method is likely to entail high cost and its boding strength is apt to be insufficient. Thus, from inexpensive and simple viewpoints, it is considered to adopt a method in which radiation cure resin is dripped onto the disc and then, is cured.

### DISCLOSURE OF INVENTION

### (Problems to be Solved by the Invention)

However, prior art has such major problems that due to the liquid material of the protector, its height becomes insufficient when its width is taken into consideration, while its width becomes unnecessarily large when its height is increased sufficiently.

### (Means for Solving the Problems)

In order to solve the above problems of prior art, a manufacturing method of an optical information recording medium, according to the present invention is characterized in that a liquid material is dripped onto a region bounded by a concave portion on a recording and reproducing face of the optical information recording medium and is cured so as to form a convex portion on the region. By the manufacturing method of the present invention, the convex portion having desired height and width can be easily formed by the liquid material such as radiation cure resin. Since the convex portion acting as a protector can be easily formed afterwards, the protector is not required to be provided on a substrate beforehand, which is advantageous for formation of a light-transmissible layer by spin coating and a two-layer processing.

In the manufacturing method of the present invention, the region is preferably interposed between two substantially concentric concave portions. Thus, the convex portion having the desired height and width can be formed easily.

In the manufacturing method of the present invention, it is preferable that a plurality of the regions each surrounded by the concave portion are provided. Thus, a plurality of the convex portions can be formed easily.

In order to solve the above problems of prior art, a manufacturing method of an optical information recording medium, according to the present invention is characterized in that a liquid material is dripped onto a protrusion on a recording and reproducing face of the optical information recording medium and is cured so as to form a convex portion on the protrusion. By the manufacturing method of the present invention, the convex portion having desired height and width can be easily formed by the liquid material such as radiation cure resin. Since the convex portion acting as a protector can be easily formed afterwards, the protector is not required to be provided on a substrate beforehand, which is advantageous for formation of a light-transmissible layer by spin coating and a two-layer processing.

In the manufacturing method of the present invention, it is preferable that the liquid material is radiation cure resin. Thus, the convex portion can be formed at low cost.

In the manufacturing method of the present invention, the concave portion is preferably formed at the time of injection molding of a substrate. Thus, the concave portion can be formed easily.

In order to solve the above problems of prior art, an optical information recording medium of the present invention includes two or more concave portions which are provided on a recording and reproducing face so as to bound at least one region and a convex portion which is formed on the region. By the optical information recording medium of the present invention, it is possible to obtain the inexpensive optical information recording medium including the convex portion having a stable shape.

Meanwhile, an optical information recording medium of the present invention includes at least one protrusion which is provided on a recording and reproducing face and a convex portion which is formed on the protrusion. By the optical information recording medium of the present invention, it is possible to obtain the inexpensive optical information recording medium including the convex portion having a stable shape.

In the optical information recording medium of the present invention, it is preferable that the convex portion is higher than a surface of a light-transmissible layer. Thus, the convex portion can act as a protector for preventing damage to the surface of the light-transmissible layer.

In the optical information recording medium of the present invention, the convex portion preferably has a width of 1 mm or more. Thus, it is possible to obtain the optical information recording medium including the convex portion having a sufficient strength.

### (Effects of the Invention)

In the optical information recording medium and its manufacturing method, according to the present invention, in case the light-transmissible layer is manufactured from the liquid material such as the radiation cure resin, the protector having the stable shape can be manufactured, so that the optical information recording medium formed with the protector can be manufactured at low cost.

In accordance with the present invention, the above advantageous effects can be gained.

### BRIEF DESCRIPTION OF DRAWINGS

FIG. 1 is a fragmentary sectional view of an optical information recording medium according to a first embodiment of the present invention.

FIGS. 2A and 2B are fragmentary sectional views showing one example of a manufacturing procedure of a manufacturing method of the optical information recording medium of FIG. 1.

FIG. 3 is a fragmentary sectional view showing another structure of a light-transmissible layer of the optical information recording medium of FIG. 1.

FIG. 4 is a fragmentary sectional view showing one example of an effect gained by a protector of the optical information recording medium of FIG. 1.

FIGS. 5A, 5B and 5C are enlarged fragmentary sectional views showing examples of a step for forming a protector in the manufacturing method of the optical information recording medium of FIG. 1.

FIG. 6 is a fragmentary sectional view showing a two-layer type optical information recording medium which is a modification of the optical information recording medium of FIG. 1.

FIGS. 7A and 7B are fragmentary sectional views showing a step for forming the light-transmissible layer in the manufacturing method of the optical information recording medium of FIG. 1 and its comparative example, respectively.

FIG. 8 is a fragmentary sectional view showing another disadvantage of the comparative example of FIG. 7B.

FIG. 9A is a top plan view of an optical information recording medium according to a second embodiment of the present invention and FIG. 9.B is a sectional view taken along the line IXB-IXB in FIG. 9A.

FIG. 10A is a top plan view of an optical information recording medium which is modification of the optical information recording medium of FIG. 9 and FIG. 10B is a sectional view taken along the line XB-XB in FIG. 10A.

FIG. 11 is a fragmentary sectional view of an optical information recording medium according to a third embodiment of the present invention.

FIG. 12 is a fragmentary sectional view of an optical information recording medium which is a modification of the optical information recording medium of FIG. 11.

FIG. 13 is a fragmentary sectional view of an optical information recording medium according to a fourth embodiment of the present invention.

FIG. 14 is a fragmentary sectional view of an optical information recording medium which is a modification of the optical information recording medium of FIG. 13.

### BEST MODE FOR CARRYING OUT THE INVENTION

Hereinafter, embodiments of the present invention are described with reference to the drawings. Unless otherwise specified, the drawings are illustrated by sectional views. In case two portions are symmetrical with respect to an axis in the drawings, only one of the two portions may be shown by omitting the other portion.

### First Embodiment

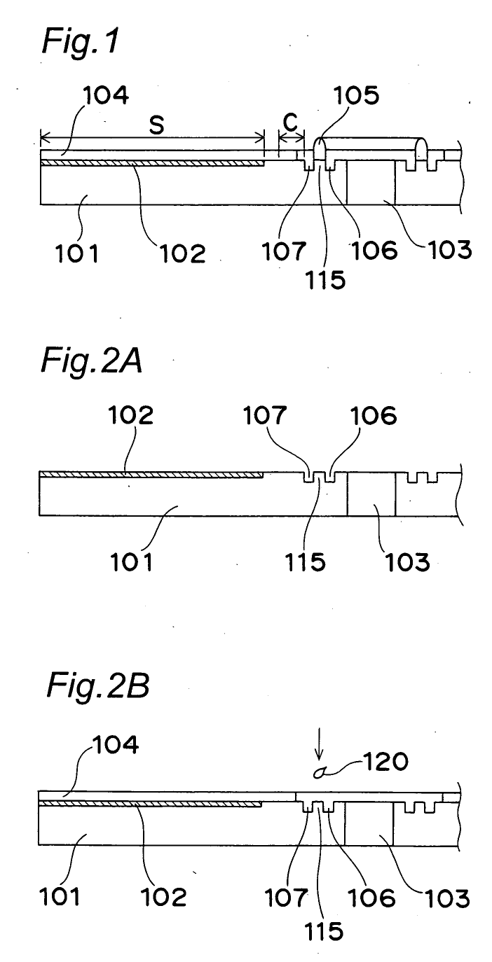

FIG. 1 shows an optical information recording medium according to a first embodiment of the present invention. In a substrate 101 of this optical information recording medium, two grooves 106 and 107 are formed substantially concentrically with a central bore 103 and an annular protector 105 is formed on a land 115 interposed between the grooves 106 and 107.

Here, one concrete example of a manufacturing method of the optical information recording medium of the present invention is described. As shown in FIG. 2A, the substrate 101 having a thickness of about 1.1 mm, a diameter of about 120 mm and the central bore 103 of about 15 mm in diameter is formed by injection molding. At this time, the grooves 106 and 107 each having a width of about 1 mm and a depth of about 200 μm are, respectively, formed at locations of radii of 8.5 mm and 11 mm. Concave and convex pits are formed on the substrate 101. The substrate 101 is formed by polycarbonate resin but may also be formed by other materials such as acrylic resin and olefin resin. In the concave and convex pits, a reflective film mainly consisting of silver is formed to a thickness of about 40 nm by sputtering so as to act as a signal recording layer 102.

As shown in FIG. 1, the substrate 101 is divided into a clamp region C ranging from 23 to 33 mm in diameter and a signal region S ranging from 42 to 119 mm in diameter. Since the protector 105 is formed on the land 115 disposed between the groove 106 having a diameter of 17 mm and the groove 107 having a diameter of 22 mm as described above, the protector 105 is disposed inside the clamp region C.

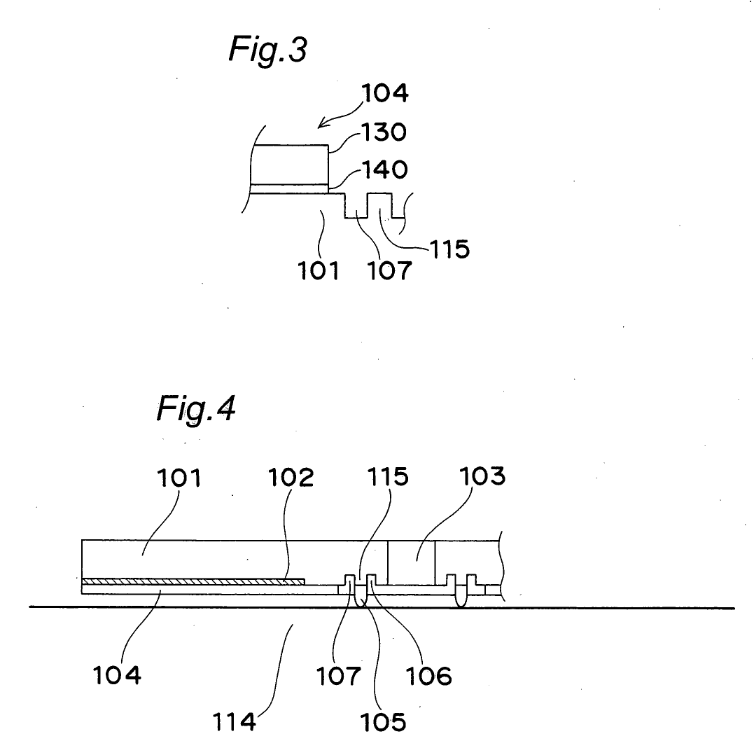

As shown in FIG. 2B, a light-transmissible layer 104 of radiation cure resin is formed on the signal recording layer 102 to a thickness of about 100 μm by a spin coating method. The reflective film may also mainly consist of aluminum or silicon. As shown in FIG. 3, by bonding a sheetlike substrate 130 to the substrate 101 with adhesive mass 140, the light-transmissible layer 104 may also be formed by the two members 130 and 140. The adhesive mass 140 may be replaced by radiation cure resin. Furthermore, a protective layer for mitigating damage to or electrification of the light-transmissible layer 104 may be provided on a surface of the light-transmissible layer 104.

When radiation cure resin 120 is dripped onto the land 115 disposed between the two grooves 106 and 107 of the disc formed with the light-transmissible layer 104 as shown in FIG. 2B and is cured, it is possible to manufacture the optical information recording medium provided with the protector 105 as shown in FIG. 1. Since the grooves 106 and 107 have angular edges, the dripped radiation cure resin 120 cannot readily enter into the grooves 106 and 107 due to its own surface tension. Thus, a width of the protector 105 can be determined easily and a height of the protector 105 also can be determined from a quantity of the dripped radiation cure resin 120.

In this embodiment, the protector 105 has a height of about 200 μm from a coated surface of the land 115. The protector 105 has a function of spacing a recording and reproducing face of the optical information recording medium away from a table 114 as shown in FIG. 4 in order to prevent damage to the recording and reproducing face when a user places the optical information recording medium on the table 114 or picks up the optical information recording medium from the table 114. Therefore, the protector 105 should be preferably made higher than a surface of the light-transmissible layer 104 of the recording and reproducing face. Furthermore, it is preferable that the protector 105 is higher than the surface of the light-transmissible layer 104 by 50 μm or more such that the recording and reproducing face of the optical information recording medium can be sufficiently spaced away from the table 114. Meanwhile, if the width of the protector 105 is too small, strength of the protector 105 drops and thus, the protector 105 should preferably have a width of 1 mm or more in a radial direction of the optical information recording medium.

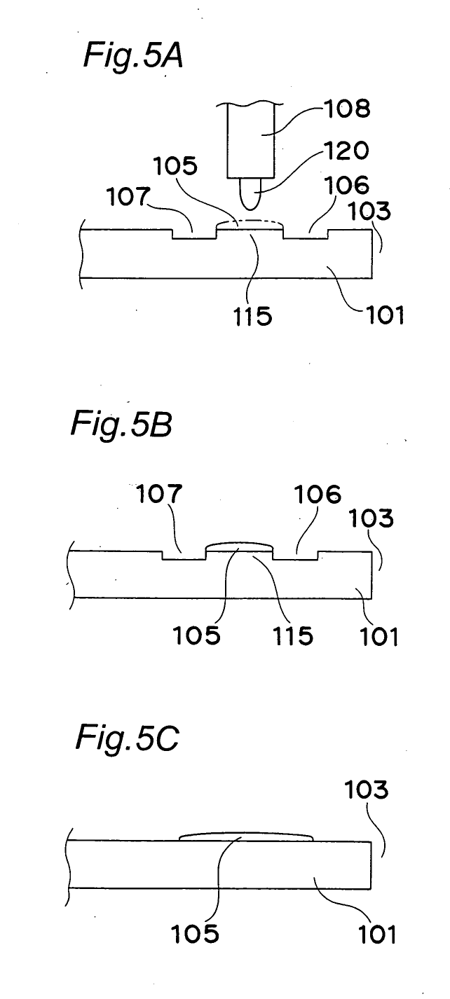

As shown in FIG. 5A, the radiation cure resin 120 for forming the protector 105 is dripped onto the land 115 from a nozzle 108. The dripped radiation cure resin 120 has a viscosity of about 200 mpa·s. The viscosity of the radiation cure resin 120 to be dripped should be preferably selected in view of the width of the grooves 106 and 107 formed on the substrate 101 and the height of the protector 105 to be formed. Coating of the radiation cure resin 120 may also be performed by other methods than that employing the nozzle 108 of FIG. 5A.

A case in which the protector 105 is formed by providing the grooves 106 and 107 as in the present invention and a comparative example in which the protector 105 is formed without providing such grooves are shown in FIGS. 5B and 5C, respectively. When the protector 105 of FIG. 5B and the protector 105 of FIG. 5C have an identical height, an effect is achieved in the present invention of FIG. 5B that the grooves 106 and 107 forcibly restrict the width of the protector 105. On the other hand, in the comparative example of FIG. 5C in which the grooves 106 and 107 are not provided, the width of the protector 105 might become too large such that the protector 105 spreads to the clamp region C.

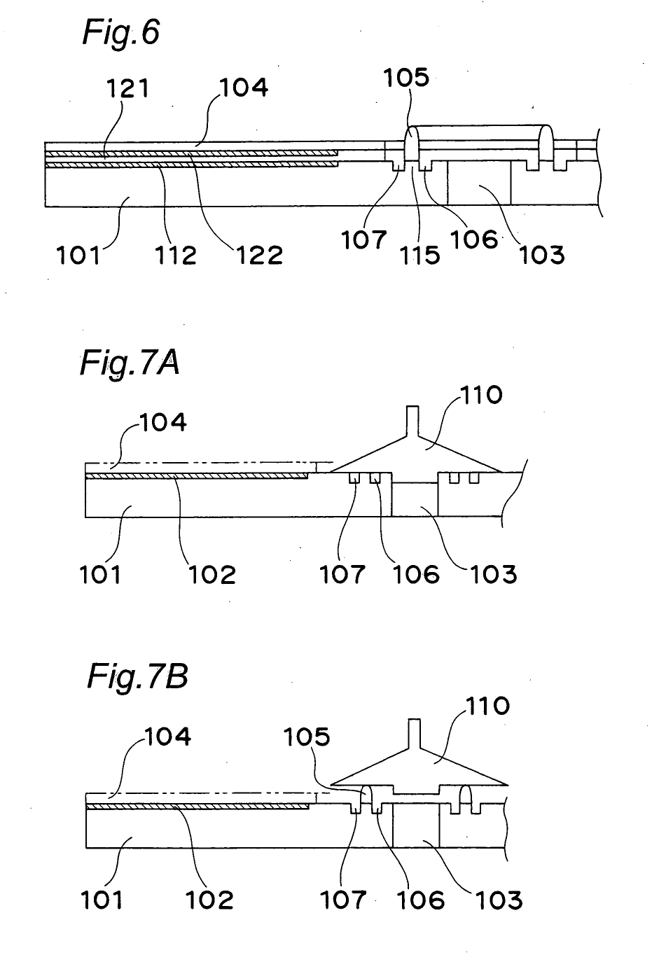

Meanwhile, the manufacturing method of the present invention can be applied to not only a so-called single-layer optical disc having the single signal recording layer as shown in FIG. 1 but a so-called two-layer optical disc having two signal recording layers as shown in FIG. 6. The two-layer optical disc of FIG. 6 includes a first signal recording layer 112 provided on the substrate 101 and a second signal recording layer 122 provided on an intermediate layer 121 disposed between the substrate 101 and the light-transmissible layer 104. In addition, it is needless to say that the manufacturing method of the present invention also can be applied to multi-layer optical discs such as a three-layer optical disc or more.

When the light-transmissible layer 104 is formed by radiation cure resin by clogging the central bore 103 with a cap 110, a case in which the protector 105 is not yet formed as in the present invention and a comparative example in which the protector 105 has already been formed are, respectively, shown in FIGS. 7A and 7B. In the present invention of FIG. 7A in which the protector 105 is formed after formation of the light-transmissible layer 104, when the light-transmissible layer 104 is formed, the protector 105 does not project above the substrate 101, so that the central bore 103 can be easily clogged with the cap 110 and thus, the light-transmissible layer 104 can be formed uniformly. On the other hand, in the comparative example of FIG. 7B in which the protector 105 is formed prior to formation of the light-transmissible layer 104, a difficulty arises in clogging the central bore 103 with the cap 110 when the light-transmissible layer 104 is formed. Namely, if the cap 110 having a diameter smaller than that of the protector 105 is employed, coating of the radiation cure resin is hindered by the protector 105. On the contrary, if the cap 110 which covers the protector 105 as shown in FIG. 7B is employed, shape of the cap 110 is restricted and diameter of the cap 110 becomes large, so that it is difficult to form the light-transmissible layer 104 uniformly.

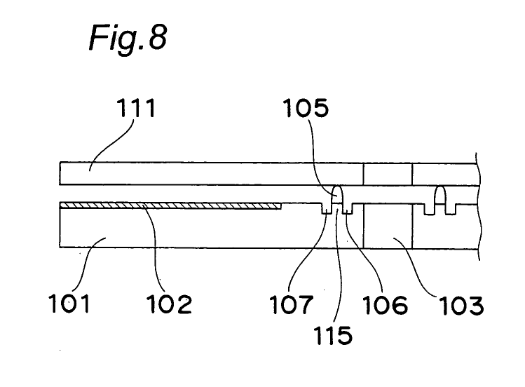

Furthermore, if the two-layer process of FIG. 6 is performed in the comparative example of FIG. 7B in which the protector 105 is formed prior to formation of the light-transmissible layer 104, a stamper 111 for transferring concave and convex pits and grooves of the signal recording layer 102 to the substrate 101 is pressed against the substrate 101 as shown in FIG. 8. At this time, since the protector 105 hinders the stamper 111 from being pressed against the substrate 101, such problems may arise that the process itself should be reappraised or upgraded to a great extent and performance of the optical information recording medium deteriorates.

Therefore, if the protector 105 is formed after formation of the light-transmittable layer 104 as in this embodiment of FIG. 7A, the optical information recording medium formed with the protector 105 can be obtained easily without incurring these drawbacks.

Meanwhile, in this specification, the term “radiation” is used to mean any electromagnetic wave capable of curing the radiation cure resin, for example, a concept including infrared ray, visible light ray, ultraviolet ray and X-ray. Hence, the radiation cure resin includes thermosetting resin.

In this embodiment, a read-only optical disc is recited as an example. However, this embodiment may also be applied to a write once read many type or a rewritable type recording and reproducing optical disc.

### Second Embodiment

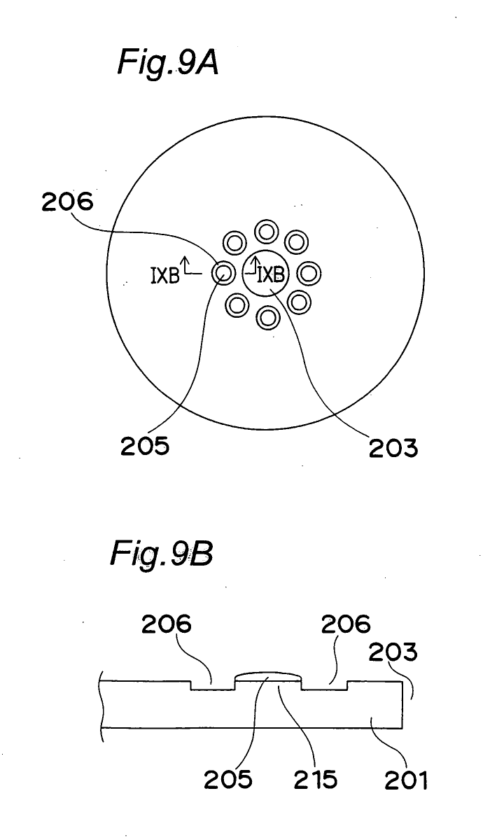

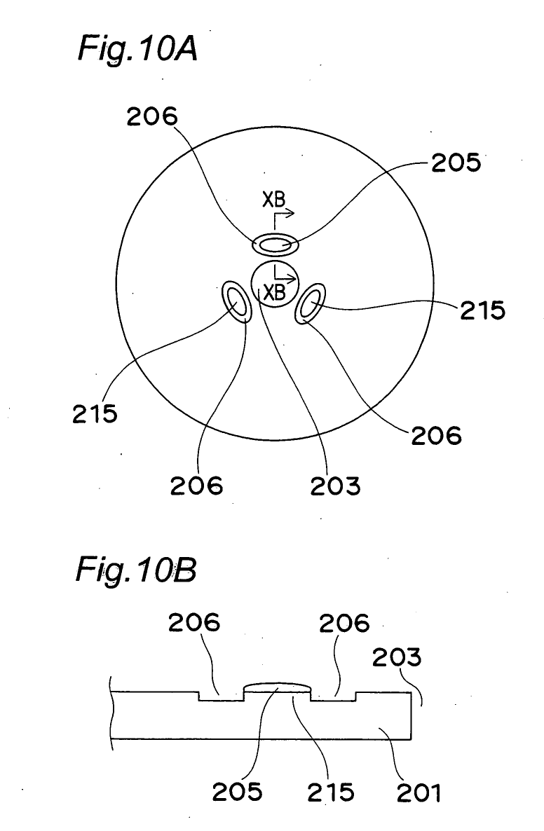

In a second embodiment of the present invention, one example of a manufacturing method of an optical information recording medium is described with reference to FIGS. 9 and 10. Meanwhile, in this embodiment, portions similar to those described in the first embodiment are abbreviated for the sake of brevity. The first embodiment shows an example in which the two substantially concentric grooves 106 and 107 are formed on the substrate 101 and the protector 105 is formed by dripping the radiation cure resin 120 onto the land 115 interposed between the grooves 106 and 107 and curing the radiation cure resin 120. The second embodiment is characterized in that liquid is dripped onto an area surrounded by a groove and is cured such that a protector having a height corresponding to a quantity of the dripped liquid is formed on the area bounded by the groove.

For example, in FIGS. 9A and 9B, a plurality of circularly annular grooves 206 are provided on a substrate 201 having a central bore 203 and a protector 205 is formed on a land 215 surrounded by each of the grooves 206. On the other hand, in FIGS. 10A and 10B showing a modification of FIG. 9, a plurality of elliptically annular grooves 206 are formed on the substrate 201 and a protector 205 is formed on a land 215 surrounded by each of the grooves 206. Meanwhile, the groove 206 is not limited to the circularly annular shape of FIG. 9A and the elliptically annular shape of FIG. 10A but may have other arbitrary shapes such as a polygonally annular shape. Thus, if the protector 205 accomplishes the original object that a surface of the optical information recording medium is less likely to be damaged, the protector 205 can also have any other shape than the circular shape of FIG. 9A and the elliptic shape of FIG. 10A.

Meanwhile, the protectors 205 may be formed on all the lands 215 but may also be formed on several ones of the lands 215. For example, as shown in FIG. 10A, an arrangement may be employed in which the protector 205 is formed on only an uppermost one of the three lands 215 and the protector 205 is not formed on each of the remaining two lands 215.

### Third Embodiment

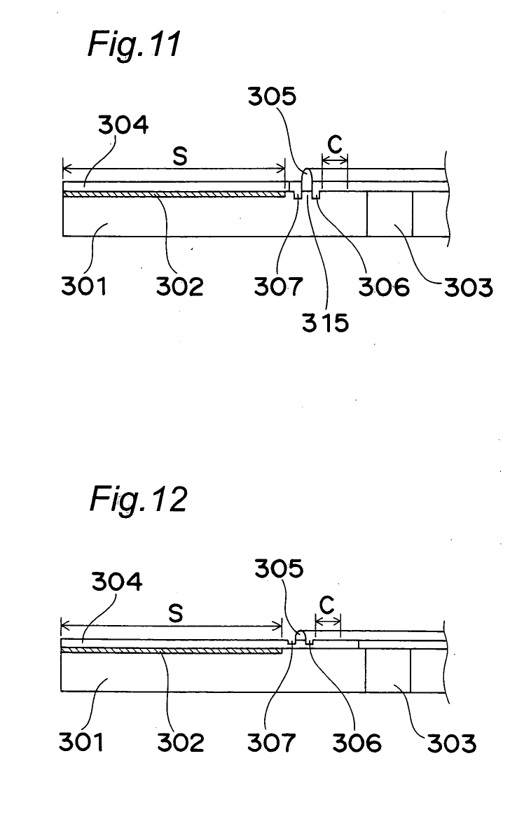

In a third embodiment of the present invention, one example of a manufacturing method of an optical information recording medium is described with reference to FIGS. 11 and 12. Meanwhile, in this embodiment, portions similar to those described in the first and second embodiments are abbreviated for the sake of brevity. In the first and second embodiments, the protector is disposed inside the clamp region C in the substrate having the clamp region C of 23 to 33 mm in diameter and the signal region S of 42 to 119 mm as described above in the first embodiment. In this embodiment, the protector is formed between the clamp region C and the signal region S from a diameter of 33 mm to a diameter of 42 mm. At this time, several examples of providing grooves for forming the protector are described.

In FIG. 11, grooves 306 and 307 are preliminarily provided on a substrate 301 having a signal recording layer 302 and a central bore 303, while a protector 305 is formed on a land 315 interposed between the grooves 306 and 307 so as to be disposed between the clamp region C and the signal region S. A light-transmissible layer 304 provided on the signal recording layer 302 may also be formed in only the signal region S. Meanwhile, in FIG. 12 showing a modification of FIG. 11, the light-transmissible layer 304 formed preliminarily with the grooves 306 and 307 is bonded to the substrate 301 and the protector 305 is formed between the grooves 306 and 307 so as to be disposed between the clamp region C and the signal region S. Moreover, after formation of the light-transmissible layer 304, the grooves 306 and 307 may be formed by performing cutting work on the light-transmissible layer 304. By performing the grooves 306 and 307, it becomes possible to form the protector 305 having a stable shape. The grooves 306 and 307 may be replaced by the groove 206 of the second embodiment.

### Fourth Embodiment

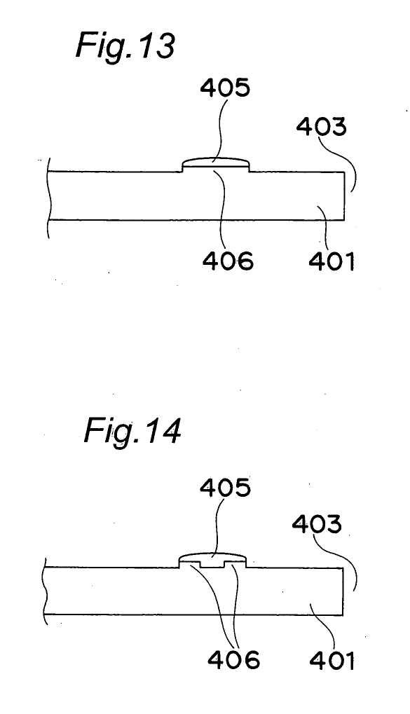

In a fourth embodiment of the present invention, one example of a manufacturing method of an optical information recording medium is described with reference to FIGS. 13 and 14. Meanwhile, in this embodiment, portions similar to those described in the first to third embodiments are abbreviated for the sake of brevity. In the first to third embodiments, the liquid material for the protector is restrained from spreading by providing the grooves such that the protector having the stable shape is formed. In this embodiment, examples are described in which by providing a protrusion on the substrate, the liquid material for the protector is restrained from spreading due to its own surface tension.

In FIG. 13, a protrusion 406 is provided on a substrate 401 having a central bore 403 and a protector 405 is formed on the protrusion 406. This protrusion 406 is made so low as not to interfere with the cap 110 of FIG. 7 or the stamper 111 of FIG. 8. The protrusion 406 is annularly formed on the substrate 401 substantially concentrically. Since surface tension is produced in the liquid material for the protector 405 by opposite edges of an upper face of even the low protrusion 406, the liquid material for the protector 405 cannot spread readily.

The low protrusion 406 may annularly extend continuously as shown in FIG. 13 but may also be provided discontinuously as shown in FIGS. 9 and 10. On the other hand, as shown in FIG. 14 illustrating a modification of FIG. 13, the protector 405 may be formed so as to straddle the two protrusions 406. As far as the protector 405 having a stable shape can be formed by utilizing the opposite edges of the upper face of the protrusion 406, the protector 405 may also be formed so as to straddle three or more protrusions 406.

The embodiments of the present invention have been described above by reciting the examples. However, the present invention is not limited to the above embodiments but can be applied to various modifications based on a technical idea of the present invention.

### INDUSTRIAL APPLICABILITY

The optical information recording medium and its manufacturing method of the present invention are useful for facilitating stable manufacture of the protector from the liquid material such as the radiation cure resin.

1-23. (canceled)

24. A method of manufacturing an optical information recording medium, said method comprising:
dripping a liquid material onto a protrusion on a recording and reproducing face of the optical information recording medium; and
curing the liquid material on the protrusion so as to form a convex portion on the protrusion.

25. The method as claimed in claim 24, wherein said optical information recording medium has a plurality of protrusions and the convex portion is formed so as to straddle the plurality of protrusions.

26. The method as claimed in claim 24, wherein the liquid material is radiation cure resin.

27. The method as claimed in claim 24, wherein the liquid material is thermosetting resin.

28. The method as claimed in claim 24, wherein the convex portion is disposed inside a clamp region of the optical information recording medium.

29. The method as claimed in claim 24, wherein the convex portion is disposed between a clamp region and a signal region of the optical information recording medium.

30. The method as claimed in claim 24, wherein the convex portion is formed after formation of a light transmissible layer.

31. The method as claimed in claim 30, wherein the light-transmissible layer is formed by radiation cure resin.

32. The method as claimed in claim 30, wherein the light-transmissible layer is formed by a sheetlike substrate and adhesive mass.

33. The method as claimed in claim 30, wherein the light-transmissible layer is formed by a sheetlike substrate and radiation cure resin.

34. An optical information recording medium comprising:
two or more concave portions which are provided on a recording and reproducing face so as to bound at least one region; and
a convex portion which is formed on the region.

35. An optical information recording medium comprising:
at least one protrusion which is provided on a recording and reproducing face; and
a convex portion which is formed on the protrusion.

36. The optical information recording medium as claimed in claim 34, wherein the convex portion is formed by radiation cure resin.

37. The optical information recording medium as claimed in claim 35, wherein the convex portion is formed by radiation cure resin.

38. The optical information recording medium as claimed in claim 34, wherein the convex portion is higher than a surface of a light-transmissible layer.

39. The optical information recording medium as claimed in claim 38, wherein the convex portion is higher than the surface of the light-transmissible layer by 50 μm or more.

40. The optical information recording medium as claimed in claim 34, wherein the convex portion has a width of 1 mm or more.
